(19) United States
(12) Patent Application Publication
(10) Pub. No.: US 2012/0276400 A1
(43) Pub. Date: Nov. 1, 2012

(54) Method for Applying a Barrier on Moulded Fibrous Product and a Product Produced by Said Method

(76) Inventor: Björn Nilsson, Kimstad (SE)

(21) Appl. No.: 13/512,055

(22) PCT Filed: Nov. 26, 2010
(86) PCT No.: PCT/SE10/51309

§ 371 Date: May 25, 2012

(30) Foreign Application Priority Data
Nov. 27, 2009 (SE) 0950909-2

(51) Int. Cl. B05D 7/24; B32B 21/00

(52) U.S. Cl. 428/537.1; 427/212

(57) ABSTRACT

The present invention relates to a method of producing a moulded fibrous product 5, said method comprising a product formed from an aqueous pulp suspension 11, said product 5 having a surface 50; covering the surface 50 with a surface barrier material 45 applied in liquid form; and drying the product 5 and the applied surface barrier material 45 to produce a moulded fibrous product 5 having a surface barrier 46; wherein a porous mould 10, 20 is provided for supporting the product 5 during the application of the surface barrier material 45; whereby the liquid surface barrier material 45 spreads on the surface 50 to fill any possible areas, so that a moulded fibrous product having a tight surface barrier 46 will be produced.

### TECHNICAL FIELD

The present invention relates to a method of producing a moulded fibrous product, said method, comprising providing a moulded, hot-pressed and dried fibrous product formed from an aqueous pulp suspension in a vat, said product having a surface intended to face upward in use of the product; covering the surface of a first side of the product with a surface barrier material applied in liquid form; and drying the product and the applied surface barrier material to produce a moulded fibrous product having a surface barrier.

### BACKGROUND ART

U.S. Pat. No. 4,337,116 discloses an inexpensive, disposable, three-dimensionally contoured container, suitable for many purposes including holding food during exposure to high temperatures for long times in either a microwave or a conventional oven without any detrimental effect to the container or the food. The container consists of an essentially impervious liner of polyethylene terephthalate directly bonded by its own substance to a pre-formed contoured base obtained by moulding to final shape nonbrowning substantially 100% bleached kraft wood pulp from an aqueous slurry thereof against an open-face suction mould, and drying the same under pressure imposed by a mating pair of heated dies. The liner is formed by bonding to the pulp base a 0.013-0.051 mm (0.5-2.0 mil) thick film of thermoformable, substantially amorphous, substantially unoriented polyethylene terephthalate.

A disadvantage with laminating a resin film onto a moulded fibrous three-dimensionally contoured container is that the process produces a lot of waste material. In addition, blisters form easily. Film is also comparatively expensive.

U.S. Pat. No. 5,573,693 discloses a container for food, which includes a paper-based substrate, and at least one grease and moisture resistant coating applied in liquid form to the paper-based substrate. The liquid coating is preferably formed from an aqueous-based dispersion of acrylic-based material. The liquid coating remains resistant to grease and moisture issuing from food at temperatures in the range of about −29° C. to 218° C. (−20° F. to 425° F.). Frozen food trays are preferably formed from the paper based substrate provided with a grease and/or moisture resistant press-applied liquid coating, and the frozen food trays may be press-formed trays, gausetted-corner trays, folded-corner trays, hinged/lidded tray assemblies or moulded pulp trays. The paper-based substrate may initially have a clay coating applied to the food-contact side thereof to prevent the liquid coating from soaking into the substrate. The liquid coating may be applied via Myer rod, Analox roll, gravure, flexographic, lithographic and off-set printing. Additionally, the liquid coating may be applied by spraying, dipping, painting and electro-plating techniques, or other commercial coating techniques known in the art.

In document GB 550,058 a method and means for moulding containers and other articles from pulp is disclosed. Fibrous pulp is compressed between a die and a mould one or both of which is or are porous and made of sintered powered metal. Said dies or moulds may be employed for coating the container or other article with an impregnant or proofing composition, which may be applied either to the outer or inner surface or both by passing the composition through the pores of the mould or die or both. However, since the composition is passed through the porous mould or die there is a problem with keeping the pore structure clean and open between every application of composition onto the containers or articles. A thorough cleaning is needed regularly in order to avoid the pores being logged with dried composition. This is time consuming, slows down the manufacture speed and hence, results in higher production costs.

Document JP 2003020600 discloses a method for application of a barrier composition to a surface of a container body made of fibrous material. Said composition is applied on the surface while, on the opposite side of the container body, a pressure reduction is applied in order to improve the distribution of the composition so as to get a more uniform and even distribution. However, no porous mould or dye supporting the container is used and, hence, the suction through the container is not performed in a defined and optimized way which leads to uneven and non-uniform distribution of composition on the surface.

However, despite the mentioning of moulded pulp trays, for obvious reasons, none of these printing techniques is suitable for applying a liquid surface barrier onto the food-contact side of a moulded pulp tray. The printing techniques are designed to operate on flat substrates, not for printing a covering surface barrier material on the inside of a food tray, soup plate or mug, for example, dipping leads to double-sided coating and, thus, a waste of surface barrier material, and with spraying, painting and electro-plating there is a risk of uneven and insufficient coverage.

A preferred process for making the moulded fibrous product, such as a food tray, plate or mug, for example, which is to be provided with a tight surface layer, is disclosed in WO 2006/057610, herewith incorporated by reference. The forming process deposits virgin or recycled fibres onto sintered forming tools via a suction in the vat or forming tank. After the forming tank, the fibrous products are pressed and heated between closely matched male and female moulds in a three-stage operation. The results of these three pressing and heating stages are an increase in the fiber density; a smoothing of the surfaces; and tension is built up in the fiber network, which increases the stiffness of the final product.

After the pressing and heating stages, the products are sent for final drying in a microwave dryer. Splitting the drying between the heating and pressing and microwave drying keeps the production rates up and eliminates the common problems of micro-cracking, strength loss and warping found in other fiber moulding techniques. The exceptional rigidity and torsional stability makes it possible for the walls of moulded products to be thinner and to be shaped in a wide range of complicated forms without cracking or deforming during the production and shipping process.

### DISCLOSURE OF THE INVENTION

The object of the present invention is to address the above mentioned complex of problems, which according to an aspect of the invention is solved by providing a method wherein a porous mould is provided for supporting the product during the application of the surface barrier material, and suction is applied through the pores of the mould. Thanks to the invention a reliably secured barrier is achieved in an efficient manner.

According to one aspect of the invention the barrier material is supplied in liquid form, which may provide the extra advantage of obtaining a self-healing effect of the liquid barrier material applied on the product, thanks to the suction affecting the liquid surface barrier material to spread on the surface to fill any possible areas that need more of the liquid surface barrier material, so that a moulded fibrous product having a tight surface barrier will be produced, despite possible irregularities in the fibre structure of the product. Thereby, a tight barrier is produced which is impermeable to substances such as water, grease and/or oxygen, and the amount of surface barrier forming liquid used may be reduced without sacrificing the imperviousness of the formed barrier.

According to an aspect of the invention, the liquid surface barrier material is applied by spraying onto the surface of a first side. Thereby, a layer of a desired thickness can be created in an easy way and the barrier material binding in a natural way to the material of the product, without risking unevenness or blistering.

According to another aspect of the invention, the liquid surface barrier material is applied by printing. Thereby, a desired amount of surface barrier forming liquid can be applied in a secure and controlled manner which can be easily integrated in the production process.

According to yet another aspect of the invention, the liquid surface barrier material is first applied onto a resilient pad and then the pad is pressed against the surface. Thereby, a greater level of control is achieved regarding the amount of surface barrier liquid used, which can result in a surface barrier of a desired thickness and evenness.

According to a further aspect of the invention, the pad is of a shape that is essentially complementary to the surface to be printed. Thereby, the entire surface can be exposed to the desired amount of surface barrier liquid, even in the case of an irregular and/or complicated shape of the moulded fibrous product. This is beneficial in designing the surface barrier and deciding factors such as thickness, evenness and resilience.

According to another aspect of the invention, a resilient pad mounted to form a cover on a male three-dimensional mould is used. Thereby, a mould which is already integrated in the process can be used for printing, and the use of a male mould is advantageous in the printing process as the layer constructed is generally more uniform in thickness and coverage.

According to yet another aspect of the invention, the liquid surface barrier material is applied onto the resilient pad by dipping the pad thereinto. This is an easy and efficient method of application and can easily be integrated with the manufacturing process. According to a further aspect of the invention, a resilient pad that is porous is used and the liquid surface material is fed through the pores of the pad. Thereby, an additional step of applying the material to the pad can be avoided and the supply of surface barrier liquid can be controlled by a tube or pipe, for instance, leading to the pad.

According to another aspect of the invention, a pattern can also be printed on the product or the surface barrier material can contain a pigment of a dye. Thereby, a desired appearance of the product can be designed, such as a specific colour or a pattern or figure. This can greatly enhance the product's desirability in specific customer groups.

According to yet another aspect of the invention, the surface barrier material can form a barrier which is impervious to oxygen. Thereby, a product such as a food product can be protected from the oxygen in air and the aging of the product can thereby be delayed or hindered, which is desirable as it prolongs the life of the product.

According to a further aspect of the invention, a surface barrier material which is biodegradable can be used. Thereby, provided that the material used for the product itself is also biodegradable, the product can be degraded in a natural way after use and will result in waste material which is environmental-friendly.

According to another aspect of the invention, the first side of the product, to which the surface barrier is applied, is defined as the side that is intended to face upwards when the product is in use. Thereby, the side which is intended to be in contact with a food product, if the product manufactured is a mug, plate, or the like, is especially suitable for containing a substance such as food or drink without said substance being able to penetrate the product and leak out into the surroundings.

According to yet another aspect of the invention, the mould that is used to hold the product when applying the surface barrier is a female mould. This is especially beneficial when applying the barrier material, since the female mould will keep the material in place during application and prevent spreading of the material into the surrounding area.

### BRIEF DESCRIPTION OF THE DRAWINGS

In the following, the invention will be described in more detail with reference to preferred embodiments and the appended drawings, wherein

FIG. 1 shows a schematic view of a manufacturing process of a moulded fibrous product,

FIG. 2 shows applying of a surface barrier onto a moulded fibrous product by means of spraying on product held by a permeable mould,

FIG. 3a-3e shows a number of process steps for applying a surface barrier by using a printing pad on a product held by a permeable mould.

### DETAILED DESCRIPTION OF THE INVENTION

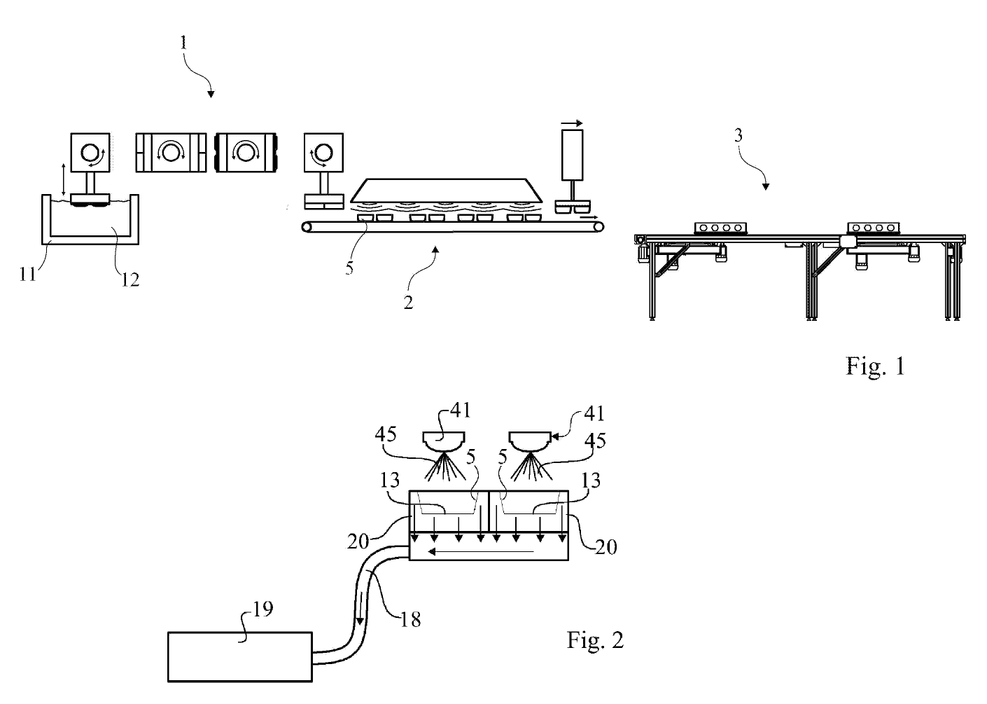

FIG. 1 is a schematic view of a manufacturing process for producing moulded fibrous products 5 showing a forming section 1 for forming a moulded pulp product 5, a drying section 2 for drying the moulded pulp product 5, and a after treatment section 3 for subjecting the dried moulded pulp product 5 to after treatment steps such as finishing the edges of the pulp products 5, packing the pulp products 5, etc. The liquid barrier material 45 is preferably applied to the product 5 at the forming section 1 or at the after treatment section 3. Depending on the stage of application, different barrier materials 45 provide different advantages, as will be described further below.

When applying the liquid barrier material 45, the moulded pulp product 5 is supported in a porous mould 10, 20 having a to the pulp product 5 complementary shape. In the forthcoming text male porous moulds are numbered by 10 and female by 20. The porous mould 10, 20 can be of the same kind as used as pulp moulds in the forming section 1, during forming and subsequent pressing. An example of a suitable female and male porous mould 10, 20 can be found in WO2006/057609 which is hereby incorporated by reference. However also other kinds of porous moulds such as e.g. described in U.S. Pat. No. 6,582,562, U.S. Pat. No. 5,603,808, U.S. Pat. No. 5,547,544, WO98/35097 could be used. Preferably the mould have an average pore diameter at the surface in the range of 1-5000 μm, preferably 5-1000 μm, more preferably 10-100 μm, and a pore density of at least 10 cm⁻², preferably at least 100 cm⁻².

Usually it is preferred to apply a surface barrier material 45 on the side of the product which is intended to face upwards, especially if the product 5 created is intended to be in contact with food or drink, such as for instance a plate or mug. Thereby, the impermeability to water and/or grease can be achieved on the side where it has the greatest effect. Therefore usually a female mould 20 would be used to support the product when applying the barrier. If, on the other hand, it is desired to have the surface barrier material 45 on the opposite side of the product, it would be advantageous to apply the liquid barrier material 45 to the product 5 while it is being held by a male mould 10.

When applying the liquid barrier material 45 to the pulp product 5; suction is applied through the porous mould 10, 20 to get a self-healing effect of the liquid barrier material 45 applied on the product 5, whereby the liquid surface barrier material 45 spreads on the surface 50 to fill any possible areas that need more of the liquid surface barrier material 45, so that a moulded fibrous product 5 having a tight surface barrier 46 will be produced. The suction can also be used to hold the product 5 to the mould 10, 20, which can be particular useful if the mould 10, 20 holding the product 5 is held sideways or facing downwards. The suction pressure is within a negative gauge pressure range from −0.1-−1 bar, preferably −0.6-−0.9 bar.

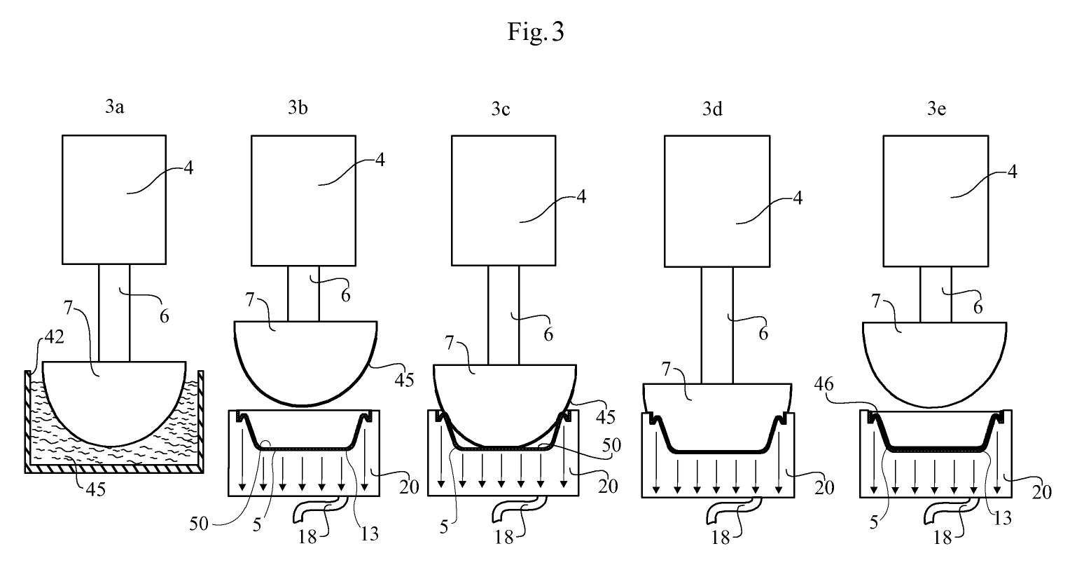

The liquid barrier material 45 can e.g. be applied to the mould by means of spraying as shown in FIG. 2, by means of mating a complementary porous mould 10, 20 having a fluid flow through the mould 10, 20 as described in relation to FIG. 3, by dipping a flexible pad to a tank containing liquid barrier material 45 and printing the barrier 46 on the product 5 as is described in relation to FIG. 3, or by other means of supplying the liquid barrier material 45 to the surface of the product 5. A common denominator for these embodiments is the use of suction through the surfaces of the supporting porous mould 10, 20 so that the liquid barrier material 45 is sucked into the material of the product 5, and providing a barrier that is mixed into the surface of the product 5. If the products 5 have small defects, i.e. spots where the thickness of the product 5 is less, more liquid barrier material 45 will be drawn to them since the suction will be greater at those spots evening filling them providing a smooth surface. This also reduces the risk of the occurrence of any pits in the barrier since the liquid barrier material will have a tendency to flow thereto and seal them.

The supporting, mould 10, 20 is highly porous and since the mould 10, 20 has a to the product 5 complementary shape, even when the product 5 has a very complex shape, e.g. having rounded corners and edges, the underpressure on the side of the mould 10, 20 opposite to the side supporting the product 5 will cause the liquid barrier material 45 to be sucked into the product 5 to flow into the product 5 in a direction that is substantially perpendicular to the surface 50 of the product 5 irrespective of the shape of the product 5. This means that also complex forms of the product 5, will be evenly and uniformly covered by the liquid barrier material 45, i.e. also e.g. corners, bends, due to the fact that substantially the same underpressure resides in all parts of the product 5. Furthermore, when being applied to the surface 50 of the product 5, the liquid barrier material 45 has a direction of flow substantially perpendicular to the surface 50 of the product 5, which means that the liquid barrier material 45 will efficiently flow/be sucked into the product 5 in holes, e.g. micropores, between the fibers in the fiber structure of the product 5 resulting in a even and uniform barrier 46. This treatment will also create a kind of “self-healing” process, since the barrier material, which is rather viscous, will more quickly flow into larger pores and consequently clog such pores, implying a successively more even distribution of the barrier material 45 into all parts of the product 5. Preferably the time of application of underpressure, the viscosity chosen and the level of underpressure is controlled to obtain a maximum of 50% penetration of the liquid barrier, more preferred max. 30%, into the body of the product, i.e. if the wall thickness is 2 mm some barrier material may be sucked into a depth of 1 mm (at position with larger pores), but more preferred merely about 0.6 mm, to not risk clogging of the support mould 10, 20.

The underpressure that is used may vary depending on application process, structure of the product and other parameters (e.g. viscosity of barrier material, temperature, etc), but normally an underpressure of between −0.1-(−0.7) bar is appropriate. However an underpressure in a lower region, ca −0.9 bar, may in some instances be preferable. In some application processes a short application time of underpressure is desired, i.e. below 3 s, preferably below 1 s, providing the advantage that it facilitates high productivity and also safeguards that no barrier material 45 will flow all the way through the product 5 since thanks to the viscosity of the barrier material, and stickiness in relation to the fibers, the time of penetration is relatively large. Hence, no clogging of the mould will occur but a sufficient layer of barrier material 45 applied. The viscosity of the barrier material may preferably be in the range of 700-1000 cps, more preferred 100-700 cps.

It is also foreseen that pigments (also to be understood to include clay) may be added to the barrier material 45, e.g. to provide a desired color and/or other property of the coating. Furthermore it is foreseen that a two step, or even more steps, process may be used, to apply a kind of laminated barrier 46. One advantage of such a plural step process, is that a thinner layer of an outer surface may than be applied, i.e. a first basis primer layer is applied in a first step and a second top layer (e.g. of a more costly kind, e.g. a modified polyester such as modified PET) in a second step. In such a process underpressure may be disposed of in the second step in some cases, but may also be an advantage in other cases.

In FIG. 2 spray nozzles 41 sprays a barrier liquid material 45 towards opposing porous female moulds 20 each having a permeable surface 13. The liquid barrier material 45 is applied to the product 5 by moving the spray nozzles 41 over the products 5 in the moulds 20. This procedure can be repeated several times to increase the thickness of the barrier, possibly by allowing the liquid barrier material 45 to dry in-between. A suction device 19 is connected to the moulds 20 via a pipe or hose 18 and creates an underpressure inside the mould 20 providing suction through its permeable surface 13.

Due to the suction the liquid barrier material 45 is sucked into the material 5 of the product, filling any unevenness, and providing a barrier that is mixed into the surface of the product 5. By controlling the amount of supplied liquid barrier material 45 the risk of excess liquid barrier material 45 can be prevented. Further, it would also be possible to use e.g. an air knife to help blowing off any excess liquid barrier material 45.

FIGS. 3a-e show a third method for applying the surface barrier to a product 5. In FIG. 3a, a holder 4, having an extendable arm 6 and ending in a printing pad 7, which by use of the arm 6 can be lowered into a tank 42 containing liquid barrier material 45. The printing pad 7 is made from a material to which the liquid barrier material 45 can adhere in such a way that a layer is formed on the surface of the pad 7 after the lowering into the tank 42.

In FIG. 3b-e, the holder 4 is no longer positioned above a tank 42 but has been moved to face instead a female mould 20 on which a product 5 has been placed against its profiled outer permeable surface 13. To the mould 20 is attached a pipe or hose 18 through which an underpressure preferably may be applied through the permeable surface 13 and the product placed there, which may provide several advantages, e.g. assisting in keeping the product 5 in position in the mould 10/20. The extendable arm 6 is moved towards the mould 20 in such a way that the pad 7 is put into contact with the outer permeable surface 13 (shown in FIG. 3c) and with enough pressure applied through the extendable arm 6 that the pad 7, which is made from a soft material, is deformed so that the surface of the pad 7 is put into contact with the entire surface of the product on the permeable surface 13 (shown in FIG. 3e). Thanks to the fine surface of the mould 10/20 a beneficial evenly distributed counter pressure may easily be achieved during “printing”. The printing pad 7 is then retracted from the mould 20, and the liquid barrier material 45 now remains on the surface 50 of the product 5 held against the outer permeable surface 13, thereby forming a surface barrier 46 on the surface 50 of the product 5. In the embodiment where suction is provided through the pipe or hose 18, the advantage may be obtained that the liquid barrier material 45 is sucked into the product 5 and can fill any voids created through inhomogeneous material distribution or other disturbances in the manufacturing process.

The pad used can have different properties depending on what is suitable for the specific process. For instance, the pad can be of a shape that is essentially complementary to the surface 50 to be printed, so that the pad can easily reach all parts of the surface 50 even if the surface 50 itself has a complex shape. The pad 7 could also be resilient and mounted to form a cover on a male three-dimensional mould 10 for essentially the same reason. Suitably, the suction through the pores of the female mould 20 is applied also to also the pores of the pad 7 to keep the liquid barrier material 45 more firmly adhered to the pad 7 before transferring it to the surface 50 of the product 5. The supply of liquid barrier material 45 could be placed inside the pad 7 and fed through pores in the pad 7, which would then be of a resilient and porous material. This would facilitate the process in that the pad 7 would not need to be dipped into a tank with the liquid before transferring the liquid barrier material 45 to the surface 50 of the product 5 thereby forming the surface barrier 46 on the surface 50.

Preferably the surface barrier material 45 is applied after drying the pulp product 5 in dryer section 2 has taken place, i.e. when the product 5 is in the after treatment process marked as 3 in FIG. 1. However, it is also possible to apply the surface barrier material 45 before entering the dryer section 2, i.e. in the forming section 1, or even within the dryer section. The materials 45 suitable for use as the surface barrier 46 vary, depending among other things on in which stage of the manufacturing process the barrier is applied. For instance in the forming section 1, the pulp product 5 can be formed through subsequent pressing steps performed at high temperatures (often above 200° C.) to dewater the pulp product 5. Therefore if the barrier is to be applied prior to a pressing step at such high temperatures, the barrier material must be able to withstand such temperatures without, for instance an aqueous starch solution could be suitable when applying the barrier when elevated temperatures will follow. Also the temperature at the drying section may limit the selection of liquid barriers that can be applied to the product 5 just before entering the drying section or within the drying section, e.g. if the temperature in the drying section is high enough polymer based materials may not be suitable. At later stages, where temperatures are lower, a water solution of styrene based polymers, such as for example styrene acrylate based polymers, styrene butadiene polymers, non ionic acryl polymer or ammonia salt of modified acrylic copolymers, dispersions of polyolefines, emulsions based on modified PET could be used. However, other suitable liquid solutions may of course also be sued, for instance based on proteins, starch or cellulose derivatives.

Parameters such as viscosity of the liquid barrier material 45, the amount of liquid barrier material 45 being applied to the product 5 as well as application duration and underpressure together define how deep into the product 5 the liquid barrier material 45 is sucked. The parameters may preferably be adjusted so as to avoid liquid barrier material 45 being sucked into the porous mould 10, 20 thereby avoiding the risk of having the pores of the mould 10, 20 clogged with liquid barrier material 45.

A starch or sulphite solution has excellent properties regarding the withstanding of grease, while the polymeric materials described are good for withstanding water as well as grease, provided that the surface barrier created by the method is dense enough.

Preferably, the surface barrier is impermeable to oxygen as well as to water and grease. Thereby, the oxygen of air can be prevented from reaching through the product 5, which can prolong the life of any food or drink placed on the product 5 since the presence of oxygen generally contributes to the aging process.

The moulded fibrous product 5 is useful not only for food trays and the like, but also for clamshells, plates, and packing material, e.g. for disposable medical products. It can be tailored to a range of specifications, making it an economically superior choice for the protective packaging, foodservice, home meal replacement and healthcare industries, for example. In design, clamshell is a form resembling the shell of a clam, with the ability to open up in the same way.

It is to be noted by the person skilled in the art that the methods described above for applying a surface barrier to a moulded fibrous product 5 being formed can be used with a variety of different manufacturing processes. The invention should be seen as being limited only by the appended claims and not by the specific preferred embodiments described above.

For instance, it has been shown that the product 5 can be held in a position so that the surface 50 of the product 5 to be covered by the barrier material 45 faces upward as well as downward. Obviously it would also be possible to have the mould 20 in a position so that the surface 50 of the product 5 to be covered by the barrier material 45 faces sideways. The advantage of having the product 5 facing downward or sideway is that any excess liquid barrier material 45 will naturally flow off the product 5. However by carefully controlling the amount of supplied liquid barrier material 45 and/or using other means such as blowing off excess liquid barrier material 45, it is also feasible to have the product 5 facing upwards

Furthermore, it would of course be possible to apply a barrier on the opposite side as well, after the first barrier has been applied. For the second barrier, it will not be sucked into the product 5 in the same way as for the first barrier, since by applying the first barrier the product has been made more or less impermeable. Therefore, when applying barriers on opposite sides, it is preferred to apply the first barrier to the side that is intended to face liquid. It would further be possible to apply multiple barriers on each side, where preferably each having different properties. Furthermore it is evident for the skilled person that the invention is not limited to application of barrier materials, but that the coating/layer that is applied may have other purposes alone or in combination, e.g. decrease or increase of friction, improved printing properties, improved/tailored finish, (e.g. non-reflecting, glossy, tactile feel, etc.) improved wear resistance, etc.

1. A method of producing a moulded fibrous product (5), said method comprising:
providing a moulded, hot-pressed and dried fibrous product (5) formed from an aqueous pulp suspension (12) in a vat (11);
covering a surface (50) of at least a first side of the product (5) with a surface barrier material (45) applied in liquid form, to produce a moulded fibrous product (5) having a surface barrier (46);
characterized by
providing a porous mould (10, 20) for supporting the product (5) during the application of the surface barrier material (45); and
using merely one porous mould (10, 20) and applying said surface barrier material (45) from an opposite side compared to said mould (10, 20).

2. A method as claimed in claim 1, characterized by applying suction through the pores of the mould (10,20) during the application of the surface barrier material (45).

3. A method as claimed in claim 1, characterized by applying said surface barrier material (45) in liquid form, and drying the product (5) and the applied surface barrier material (45).

4. A method as claimed in claim 3, characterized by applying the liquid surface barrier material (45) by spraying the liquid surface barrier material (45) onto the surface (50) of the first side.

5. A method as claimed in claim 3, characterized by applying the liquid surface barrier material (45) by printing.

6. A method as claimed in claim 5, characterized by first applying the liquid surface barrier material (45) onto a resilient pad (7) and then pressing the pad (7) against the surface (50).

7. A method according to claim 6, wherein the pad (7) is of a shape that is essentially complementary to the surface (50) to be printed.

8. A method as claimed in claim 7, characterized by using a resilient pad (7) mounted to form a cover on a male three-dimensional mould.

9. A method as claimed in claim 6, characterized by applying the liquid surface barrier material (45) onto the resilient pad (7) by dipping the pad (7) there into.

10. A method as claimed in claim 5, characterized by using a resilient pad (7) that is porous and feeding the liquid surface material (45) through the pores of the pad (7).

11. A method as claimed in claim 5, characterized by printing also a pattern on the product (5).

12. A method as claimed in claim 1, characterized by using a surface barrier material (45) that forms a barrier (46), which is impervious to oxygen.

13. A method as claimed in claim 1, characterized by using a surface barrier material (45) that forms a barrier (46), which is biodegradable.

14. A method as claimed in claim 1, characterized by using a surface barrier material (45) containing a pigment or a dye.

15. A method as claimed in claim 1, characterized by the first side of the product (5) being defined as the side that is intended to face upwards when the product (5) is in use.

16. A method as claimed in claim 1, characterized by the mould that is used to hold the product (5) when applying the surface barrier material (45) being a female mould (20).

17. A method as claimed in claim 1, characterized by the material (45) of the surface barrier (46) belonging to the group of aqueous starch solution, protein solution, styrene based polymers, styrene acrylate based polymers, styrene butadiene polymers, non ionic acryl polymer, ammonia salt of modified acrylic copolymers, proteins, or cellulose derivatives.

18. A method as claimed in claim 1, characterized by the mould having an average pore diameter at the surface in the range of 1-5000 μm, preferably 5-1000 μm, more preferably 10-100 μm and a pore density of at least 10 cm⁻², preferably at least 100 cm⁻².

19. A moulded fibrous product (5) comprising:
a moulded, hot-pressed and dried fibrous product formed on a mould from an aqueous pulp suspension in a vat; and
a first surface opposite the side of the moulded, hot-pressed and dried fibrous product that contacts the mould, the first surface covered with a surface barrier material (45) applied to the moulded, hot-pressed and dried fibrous product in liquid form.
